(19) United States
(12) Patent Application Publication
(10) Pub. No.: US 2013/0060582 A1
(43) Pub. Date: Mar. 7, 2013

(54) UNDERWRITING SYSTEM AND METHOD ASSOCIATED WITH A CIVIC IMPROVEMENT PLATFORM

(71) Applicants: Brian M. Cutino, Windsor, CT (US); Bryan Matthew Johnson, Portland, CT (US); Rohini H. Pandhi, Perrysburg, OH (US); Heather Anne Serignese, Cromwell, CT (US); David J. Turner, Farmington, CT (US)

(72) Inventors: Brian M. Cutino, Windsor, CT (US); Bryan Matthew Johnson, Portland, CT (US); Rohini H. Pandhi, Perrysburg, OH (US); Heather Anne Serignese, Cromwell, CT (US); David J. Turner, Farmington, CT (US)

(21) Appl. No.: 13/223,638

(22) Filed: Sep. 1, 2011

(51) Int. Cl. G06Q 40/00

(52) U.S. Cl. 705/4

(57) ABSTRACT

A system for underwriting using civic improvement platform based data is disclosed. In some embodiments, an automated insurance underwriting platform for rating and pricing insurance policies through the accessing and evaluating of civic improvement platform based information is implemented. According to some embodiments, civic improvement platform data associated with a potential entity to be insured may be received. The civic improvement platform data may be, for example, associated with user safety reports received by a civic improvement platform. The civic improvement platform data may be analyzed, and an underwriting decision for the potential entity to be insured may be made based at least in part on said civic improvement platform data. The underwriting decision may be associated with, for example, a premium for an insurance policy, a benefit for an insurance policy, an insurance policy renewal, and/or an insurance policy premium adjustment.

### BACKGROUND

Underwriting of insurance policies for individuals and businesses involves the application of certain established statistical methods, detailed reviews of historical loss information coupled in with a skilled underwriter's judgment and experience. Currently, many conventional data sources are used including credit rating agency data, historical accident data, and claims data to make underwriting decisions. Furthermore, commercial underwriting poses additional difficulties in the underwriting area. Small and medium size businesses span a wide range of business types, and involve a wide range of business risks and risk characteristics, making it difficult to generate and analyze information to produce rating and pricing policies that can be reliably and consistently applied to different businesses in different geographical locations, industries and sizes.

Current underwriting processes and systems do not adequately take into account the vast array of information more recently available via the Internet. The more explosive recent growth of the Internet, and more particularly, civic improvement platform type of sites, has developed into a largely untapped area for potentially valuable underwriting information.

It would be desirable to provide systems and methods for underwriting by leveraging civic improvement platform information in the underwriting process.

### SUMMARY OF THE INVENTION

According to some embodiments, systems, methods, apparatus, computer program code and means for underwriting using civic improvement platform based data is disclosed. In one embodiment, the invention relates to a system to underwrite insurance policies using civic improvement platform based data, comprising a communication device to exchange civic improvement data associated with a potential entity to be insured; a processor coupled to the communication device; and a storage device in communication with said processor and storing instructions adapted to be executed by said processor to analyze said civic improvement platform data; and transmit an underwriting decision for the potential entity to be insured based at least in part on said civic improvement platform data.

A technical effect of some embodiments of the invention is an improved and computerized insurance underwriting, rating and quoting system providing improved rate and pricing specificity and flexibility for insurance policies. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIGS. 2 and 3 illustrate civic improvement platform displays in accordance with some embodiments.

FIG. 4 is block diagram of a system according to some embodiments of the present invention.

FIG. 5 illustrates a method according to some embodiments of the present invention.

FIG. 6 illustrates a verification process according to some embodiments of the present invention.

FIG. 7 is a verification data flow according to some embodiments of the present invention.

FIG. 8 is a process work flow associated with a new insurance policy according to some embodiments of the present invention.

FIG. 9 is a block diagram of an underwriting platform in accordance with some embodiments of the present invention.

FIG. 10 is an illustrative example of a portion of an underwriting database in accordance with some embodiments.

### DETAILED DESCRIPTION

Underwriting of insurance policies for individuals and businesses involves the application of certain established statistical methods, detailed reviews of historical loss information coupled in with a skilled underwriter's judgment and experience. The recent growth of civic improvement platform type of sites has developed into a largely untapped area for potentially valuable underwriting information. It may therefore be desirable to provide systems and methods for underwriting by leveraging civic improvement platform information in the underwriting process.

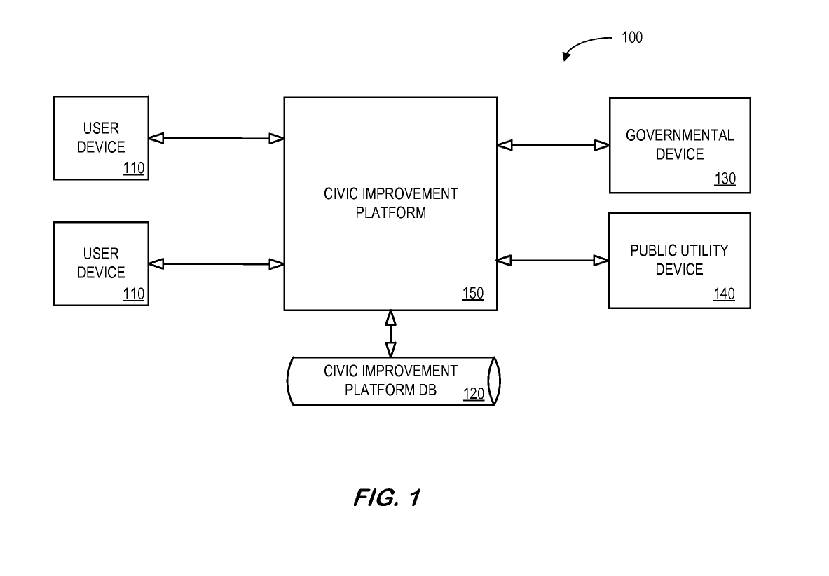

In some cases, a “civic” improvement platform may let users report unsafe conditions. As used herein, a civic improvement platform may be associated with a group of people and/or one or more locations, such as, for example, a city, town, neighborhood, community, and/or municipality. For example, a user might notice that a traffic light in his or her hometown is not working properly and report that fact to a remote civic improvement platform via a communication network (e.g., by transmitting a message from his or her smartphone to the platform via the Internet or wireless telephone network). FIG. 1 is block diagram of a system 100 including such a civic improvement platform 150 according to some embodiments of the present invention. Examples of civic improvement platforms may include, for example, the SeeClickFix web site, the Virginia Department of Transportation telephone road condition service, the SpotCrime crime data aggregator, and New York Cities 311 telephone reporting system. Note that a civic improvement platform might be associated with a social networking platform (e.g., Facebook or Twitter).

In this example, the civic improvement platform 150 may communicate with a number of remote user devices 110 via a communication network. For example, the user devices 110 may represent wireless telephones, Personal Computers (PCs), laptop computers, automobile devices, or any other apparatus able to exchange information with the civic improvement platform 150. The user may use the user device 110 when he or she notices a safety issue, such as a road condition (e.g., an unusually large pothole), a traffic sign condition (a “Stop” sign that has fallen down), a streetlight condition, a traffic light condition, an electrical wire condition (e.g., a broken power line across a roadway), a water hazard, a weather hazard (e.g., an icy bridge), a street condition, a plant hazard (e.g., overgrown bushes blocking a driver's line of sight), a sidewalk condition, a guardrail condition, and/or a criminal activity (e.g., a sign vandalized with graffiti), etc. As other examples, a user might submit information via a Facebook account, a web blog, or a google plus account.

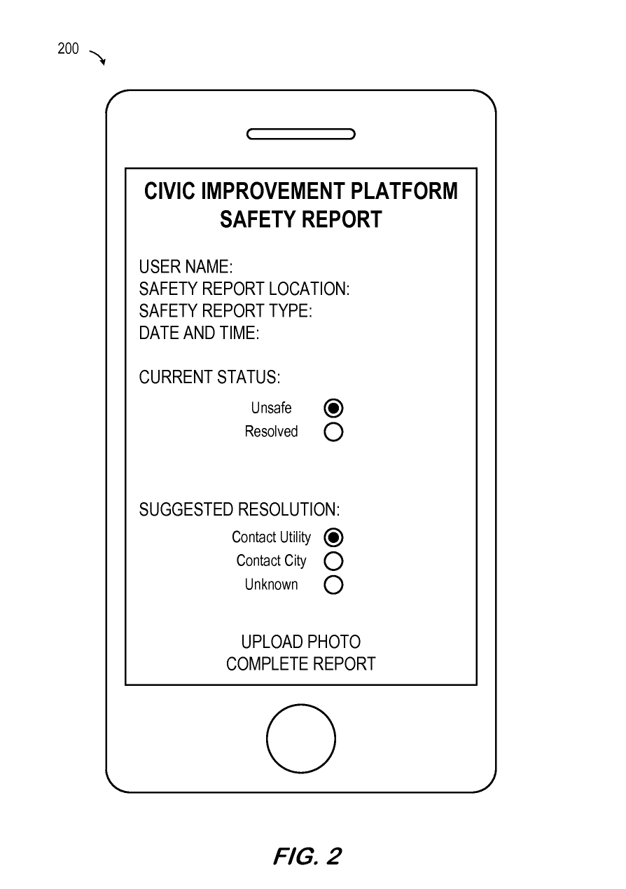

According to some embodiments, the user device 110 transmits a safety report to the civic improvement platform 150. The user safety report might include, for example, a user identifier, a location (e.g., a street address or latitude and longitude information), a time and date, image information (e.g., a video or photograph taken with his or her smartphone), and/or an insurance identifier. Note that a safety report might be pushed from user device 110 to the civic improvement platform 150 or pulled from the user device 110 to the civic improvement platform 150 (e.g., on a periodic basis). FIG. 2 illustrates a civic improvement platform display 200 that may be used to enter and transmit a safety report via a smartphone in accordance with some embodiments. The display 200 might be associated with, for example, a smartphone and may include one or more fields through which a user can enter information about safety issues he or she has noticed. According to some embodiments, the display 200 also lets a user associate a photograph or video with the safety report.

The civic improvement platform 150 may store information about safety reports in a civic improvement platform database 120 and/or forward information about safety reports to a governmental device 130 (e.g., a governmental agency associated with a police or roadway maintenance department) and/or a public utility device 140 (e.g., associated with a water or electrical utility). In this way, a solution to the safety issue may be implemented (e.g., a broken streetlight may be repaired). According to some embodiments, information from the civic improvement platform 150 may be supplemented with information from public and/or governmental databases (e.g., associated with a health department or department of motor vehicles).

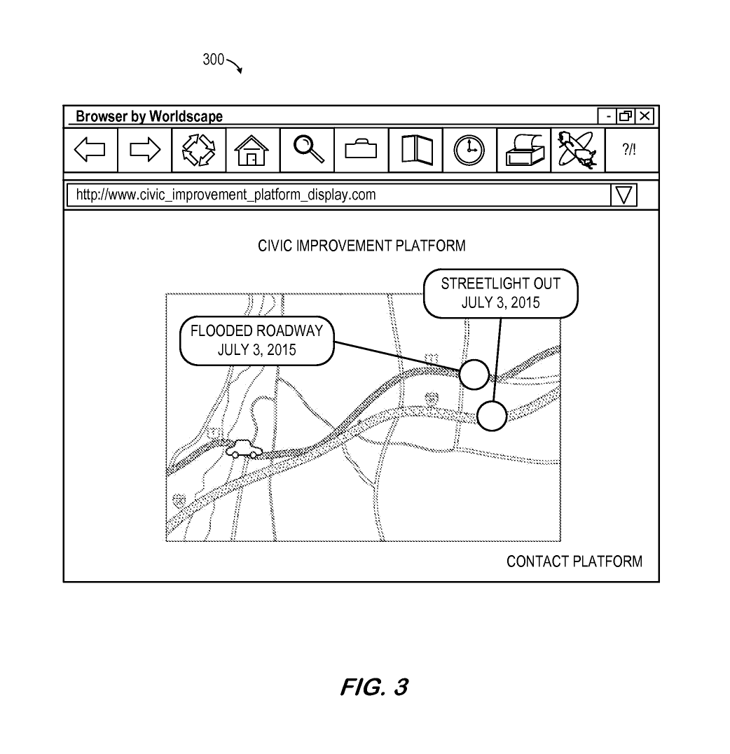

The civic improvement platform 150 may also transmit information about known safety issues to user devices 110. For example, FIG. 3 illustrates a graphical display 300 of some known safety issues via a website displayed by an Internet browser executing at a user's computer. The display 300 might be associated with, for example, a user's PC or other device executing a web browser. Moreover, the display might include information about safety reports submitted by the user and/or information submitted by other users (e.g., aggregated safety information).

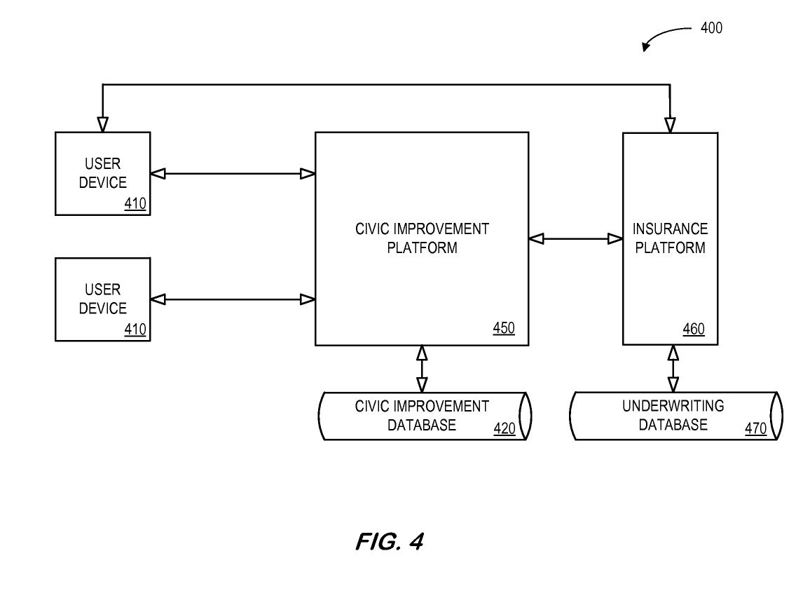

According to some embodiments, information received by the civic improvement platform 150 and/or stored in the civic improvement platform database 120 may be used to improve insurance underwriting decisions. For example, FIG. 4 is a block diagram of an insurance underwriting system 400 according to some embodiments of the present invention. The system 400 may, for example, facilitate underwriting as well as perform the quoting, rating and pricing of certain policies using civic improvement platform based data. For exemplary purposes, such sites/networks may include proprietary municipality web pages, SeeClickFix.com, SpotCrime.com, and other similar sites. In the present invention, both individual and business/commercial user safety reports from one or more of the sites may be used to underwrite, rate, offer, price, renew or otherwise evaluate insurance for one or more entities based at least in part on the civic improvement platform based data. Moreover, such information may be used to offer certain parties a discount (or surcharge) or a modified benefit or deductable amount in connection with an insurance policy. As other examples, such information may be used to facilitate marketing campaigns (e.g., to target a particular area as potentially having desirable customers based on safety reports) and/or to attempt loss control in connection with a particular business, user, or geographic area.

As before, a civic improvement platform 450 may communicate with a number of remote user devices 410 via a communication network. The user may use the user device 410 (when he or she notices a safety issue) to transmit a safety report to the civic improvement platform 450. For example, in some embodiments the user devices 410 may be associated with an iPhone® from Apple, Inc., a BlackBerry® from RIM, a mobile phone using the Google Android® operating system, a portable or tablet computer (such as the iPad® from Apple, Inc.), a mobile device operating the Android® operating system or other portable computing device having an ability to communicate wirelessly with a remote entity such as civic improvement platform 450 and/or insurance platform 460

The civic improvement platform 450 may store information about safety reports in a civic improvement database 420 and/or forward information about safety reports to governmental and/or public utility devices.

According to some embodiments, an “automated” insurance underwriting platform 460 may be provided for accessing and evaluating the civic improvement platform based data. By way of example only, the underwriting platform 460 may be associated and/or communicate with a PC, an enterprise server, a database farm, and/or a consumer device. The automated insurance underwriting processing platform 460 may, according to some embodiments, perform both personal lines and commercial underwriting, create rating schedules, and price and rate individual and business policies using those rating schedules. Pursuant to some embodiments, underwriting platform 460 accesses certain information in the civic improvement database 420 for enhanced underwriting in accordance with the present invention. Note that multiple platforms 450, 460 and/or databases 420, 470 may be provided in accordance with any of the embodiments described herein (e.g., the insurance platform 460 might aggregate data from multiple independent civic improvement platforms 450).

As used herein, devices including those associated with the automated insurance processing platform 460, and any other device described herein may exchange information via any communication network 460 which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The automated insurance processing platform 460 may include a number of modules or components, including one or more underwriting modules, quoting modules, and/or issuing modules. As will be described further below, the underwriting modules may be used in conjunction with the creation and updating of one or more rating schedules for use in pricing and rating insurance policies pursuant to embodiments of the present invention. For example, in some embodiments, the underwriting modules are used to analyze both conventional underwriting data such as historical loss information in conjunction with civic improvement platform based data for use in rating and pricing business insurance policies. The quoting and issuing modules may be used in conjunction with the quoting, rating and pricing of insurance policies (e.g., in response to requests for quotes received from a user device 410 such as a mobile device, web server or agents operating agent devices, etc.). Note that such underwriting modules, quoting modules, and/or issuing modules may be associated with various types of insurance policies, including automobile and home insurance policies, for individuals and/or companies. Note that the automated insurance processing platform 460 might arrange for a discount or benefit adjustment instead of (or in addition to) updating or accessing a rating schedule in connection with the underwriting process.

Although a single automated insurance processing platform 460 is shown in FIG. 4, any number of such devices may be included. Moreover, various devices described herein might be combined according to embodiments of the present invention. For example, in some embodiments, the automated insurance processing platform 460 and associated modules might be co-located and/or may comprise a single apparatus. In some embodiments, some or all of the underwriting analysis may be performed using a spreadsheet based program or other analytic program utilizing one or more servers or server farms in a network based environment.

The automated insurance underwriting platform 460 and analysis modules may also access information in the civic improvement database 420 and/or an underwriting database 470. The underwriting database 470 may include, for example, risk characteristic data and historical loss data associated with previously-issued insurance policies. As will be described further below, the risk characteristic data and the historical loss data may be used by an analysis module in the creation and updating of rating schedules for the storage in one or more rating databases for use by the insurance platform 460 in quoting, pricing and issuing new insurance policies.

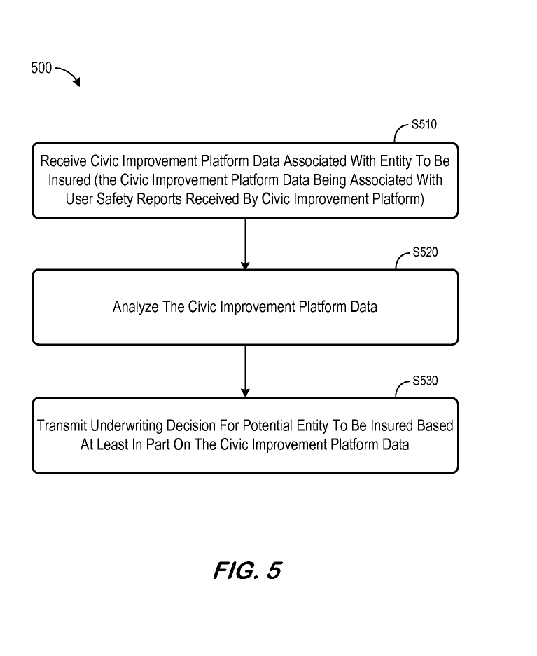

FIG. 5 illustrates a method that might be performed, for example, by some or all of the elements of the system 400 described with respect to FIG. 4 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The process 500 may be performed to generate or update an underwriting database to allow the rating, quoting, pricing and issuance of insurance policies using features of the present invention. Pursuant to some embodiments, the process 500 includes initiating an underwriting process. In one embodiment, electronic underwriting is initiated at an agent terminal or a direct to business owner terminal where an application for insurance by the potential insured triggers the electronic underwriting process.

At S510, civic improvement platform data associated with a potential entity to be insured (e.g., a person or business) is received. The civic improvement platform data is associated with user safety reports received by the civic improvement platform. Note that the civic improvement platform may be adapted to forward information associated with user safety reports to a governmental agency and/or a public utility. Moreover, user safety reports (e.g., associated with a road condition, a traffic sign condition, or a streetlight condition) may include a user identifier, a location, a time and date, image information, and/or an insurance identifier (e.g., an existing policy number).

At S520, the civic improvement platform data is analyzed. The analysis might be associated with, for example, an overall number of safety reports associated with the potential entity to be insured, a frequency of safety reports associated with the potential entity to be insured, a quality of safety reports associated with the potential entity to be insured, and/or a point value or score associated with the potential entity to be insured.

Consider, for example, safety reports that include some or all of the following information: User name; Date and time; Summary of Issue; Description of Issue; a Geo-tag; and/or a Photo or video (if applicable). This type of information may then be used to build a correlation between loss cost and civic safety scores calculated based on the safety reports.

According to some embodiments, safety reports may be automatically or manually placed into a category (e.g., by the user or an operator associated with a platform or insurance provider). Examples of such categories may include: Auto (e.g., in connection with a Road Condition, Traffic Condition, Traffic Device Incident, and/or Neighborhood quality of life data); Home (e.g., in connection with a Property Issue or Neighborhood quality of life data); and/or Commercial (e.g., in connection with a Property Issue).

When a safety report is to be automatically characterized, the system may search for keywords (e.g., within a Summary or Description of an issue). By way of example, finding one or more of the following terms might result in a safety report being categorized as an Automobile (Road Condition) Issue: Pot hole; Cement; Asphalt; Road; Power lines; Telephone Pole; Light post; Road light; Flooding+Road (where “+” indicates that both terms were found); Ice+road; Tree+Road; Animal+Road; Crack; Unmarked Road; Faded Paint; Outage; Corner; Intersection; Garbage build up+Road; Median; Shoulder; Expressway; Construction; Cones; Tollgate; Toll; Sinkhole; Deer; Fence+road; Sewer; Manhole; Drain; HOV; lane; Highway; Rumble strips; Guardrail; and/or Mile marker

According to some embodiments, the fact that a user has joined a civic improvement program may, in and of itself, indicate that the user will tend to be a better risk as compared to an average person. Moreover, frequent reports submitted by a user may indicate that he or she is an even better risk. As still another example, the quality and/or accuracy of reports submitted by a user may be taken into account in connection with the underwriting process.

Note that safety reports may also provide information about routes that are frequently traveled by a user. Similarly, safety reports may also provide information about locations that are frequently visited by a user. This information may then be used to adjust a risk profile and/or in connection with an underwriting process (e.g., when a user is frequently in a neighborhood where cars are often vandalized). According to some embodiments, the impact of safety reports may be weighted based on, for example, a population density (e.g., it might be naturally expected that a more densely populated area would generate more safety reports). As another example, an area with little or no wireless telephone service might be expected to generate fewer safety reports.

According to some embodiments, telematics data may be integrated with the civic improvement platform data (e.g., combining the driver's route and civic improvement data may enable in insurer to make underwriting/pricing changes to existing policies at renewal). For example, Smith Avenue might be known to have traffic hazards and quality of life issues. Using data points captured with civic improvement platforms and telematics data, in insurer might determine that a policy holder drives on road on a routine basis. The insurer could then increase premiums for that policy holder as the policy holder's risk characteristic increases. Or, insurer might make a suggestion to that policy holder to change their typical route to receive a discount on his or her auto insurance premium.

An insurer might also use data collected from civic engagement platforms to augment a risk analysis for certain territories. For example, one territory might be classified as a safe area (and would add no additional premium to policy holders if they garage their vehicle there). In other cases, data from civic engagement platforms might show the contrary, enabling an insurer to price with greater precision using information from the safety reports.

According to some embodiments, a table associated with different factors may help an insurer develop discounts and/or price risk in a more efficient and accurate manner. For example, Table I is one illustrative example of how user-submitted safety reports might be used to assign a “civic score” to that user:

TABLE I

| Item | Criteria | Civic Score |
|---|---|---|
| number of issues | 0 | 0 |
| reported within | 1-5 | 5 |
| the last year | 6-10 | 10 |
| | 11-20 | 15 |
| | 21+ | 20 |
| percent of issues | 0 | 0 |
| reported with | 25% | 5 |
| image/video | 50% | 10 |
| | 75% | 15 |
| | 100% | 20 |
| percent of issues | 0 | 0 |
| reported now | 25% | 5 |
| deemed resolved | 50% | 10 |
| | 75% | 15 |
| | 100% | 20 |

Thus, a number of issues reported by a user (e.g., within the last year), the use of image and/or video attachments in connection with safety reports, and/or whether or not a user's safety reports have been resolved may be used to assign a civic score to the user (e.g., by adding the scores associated with the different types of items). This information might then be used, according to some embodiments, in connection with an underwriting process (e.g., to adjust a price or provide a benefit to the user). For example, Table II is one illustrative example of how pricing might be impacted by civic engagement platforms:

TABLE II

| Item | Criteria of Civic Score | Premium Factor |
|---|---|---|
| No Discount | 0-15 | 1.0 |
| Mid-Discount | 16-30 | 0.98 |
| Full-Discount | 31-60 | 0.95 |

Thus, a user who received a civic score of 25 might have his or her premium multiplied by 0.98 (e.g., he or she would receive a “mid-discount” of 2 percent).

Referring again to FIG. 5, at S530 an underwriting decision for the potential entity to be insured is generated and/or transmitted based at least in part on the civic improvement platform data. The underwriting decision may be, for example, associated with a premium for an insurance policy, a benefit for an insurance policy, and/or an insurance policy renewal. Moreover, the insurance policy may be associated with automobile insurance, life insurance, a wealth management insurance product, personal injury insurance, and/or property insurance. According to some embodiments, the underwriting decision is further based on conventional underwriting data (e.g., traditional risk factors). Note that the underwriting decision might be associated with a discount or other benefit to be provided in connection with an insurance policy.

Note that accessing civic improvement platform data might be associated with a predetermined agreement between the insurer and one or more civic improvement platforms to provide the information from a civic improvement database to the insurance company. The process 500 described herein might further by apply weighting factors to the civic improvement platform data. According to some embodiments, weighting factors may be generated and applied to allow the calculation of a professional liability insurance premium for a person or business. For example, weighting factors may be generated and applied in connection with: a user safety report credibility rating factor, an amount of user safety reports factor, a current or dated information factor and/or a specificity of data factor. These factors might allow more accurate and predictive pricing of personal and/or business insurance premiums.

According to some embodiments, text mining of user safety report information may be implemented. In certain instances, a user generated safety report may be supplemented with follow-up information from a governmental agency (e.g., confirming the safety issue). Either or both types of data may be used in the underwriting process of the present invention including a combination of safety data from site XX and safety data from site YY. Moreover, the process may combine traditional underwriting data with civic improvement platform based data. In one exemplary embodiment, civic improvement platform based data may be combined with a description of a potential insured's operation and the standard industrial codes (“SIC”), which are associated with the potential insured's business. Each of the SIC records may be linked to underwriting guidelines established by the insurance carrier and may be combined with the civic improvement data to perform more enhanced underwriting. According to some embodiments, certain keywords (e.g., “dangerous” or “hazardous”) might be looked for and, when found, used to adjust underwriting parameters.

Note that the process 500 might be performed in connection with a newly initiated electronic underwriting decision. According to some embodiments, the process 500 might be performed on a periodic basis (e.g., when an existing agreement is up for renewal). Moreover, the user safety reports accessed by the process 500 might, according to some embodiments, be associated with a predetermined period of time (e.g., only the previous six months). As another approach, older safety reports could be given less weight as compared to newer ones.

In other embodiments, the civic improvement data may be used in conjunction with one or more predictive models to take into account a large number of underwriting parameters. The predictive model(s), in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior data and outcomes known to the insurance company. The specific data and outcomes analyzed vary depending on the desired functionality of the particular predictive model. The particular data parameters selected for analysis in the training process are determined by using regression analysis and/or other statistical techniques known in the art for identifying relevant variables in multivariable systems. The parameters can be selected from any of the structured data parameters stored in the present system, whether the parameters were input into the system originally in a structured format or whether they were extracted from previously unstructured text, such as from text based civic improvement and user safety report data.

In the present invention, the selection of these weighting factors are to improve the predictive power of the electronic underwriting process, as well as to increase the perceived or actual fairness of ratings/recommendations on a site by site basis. For example, more established and highly frequented civic improvement sites may be associated with a higher credibility factor, while newer, less established sites would be associated with a relatively lower credibility factor. By way of further example, more current user safety reports may be accorded a higher weighting while older, less current reports would be weighted lower.

According to some embodiments, information about a user might be used to adjust one or more weighting factors. For example, location information associated with a user might be used to adjust one or more weighting factors. For example, a user who generates a safety report from a work site might be given more credibility as compared to other user. As other examples, a user who has a high reputation on a web site, who generates many safety reports, and/or who has experienced a lot of transactions with the potential insured might be associated with a relatively high weighting factor. Moreover, the inclusion of image, video, and/or audio information might increase a weighting factor associated with a safety report.

The system of the present invention may be used as a gate or trigger within an underwriting process to screen or refer insurance applicants for more enhanced underwriting. In some embodiments, applicants that are to be considered for possible referral for more underwriting are selected on a real-time basis according to certain pre-determined criteria. For example, the system may automatically flag or tag applicants based on a certain threshold of user generated safety reports.

In the present invention, an underwriting referral may be done by the system automatically e-mailing or transmitting the tagged electronic application file to an underwriter for further review. If more than one underwriter is available to receive the referral of the file, then the computer system may automatically select the underwriter who is to receive the referral based on one or more factors such as one or more attributes of the insurance/applicant, the underwriter's qualifications and/or experience, the underwriter's current workload, etc. The underwriter's role, at this point, is to review the file, confirm that the referral is warranted, proceed with further analysis/investigation of the applicant, and then make an underwriting decision based on the additional underwriting performed which was triggered by the user safety reports and/or civic improvement platform based data.

As a result of the embodiments described herein, improved underwriting, rating and pricing for personal and business insurance policies may be achieved.

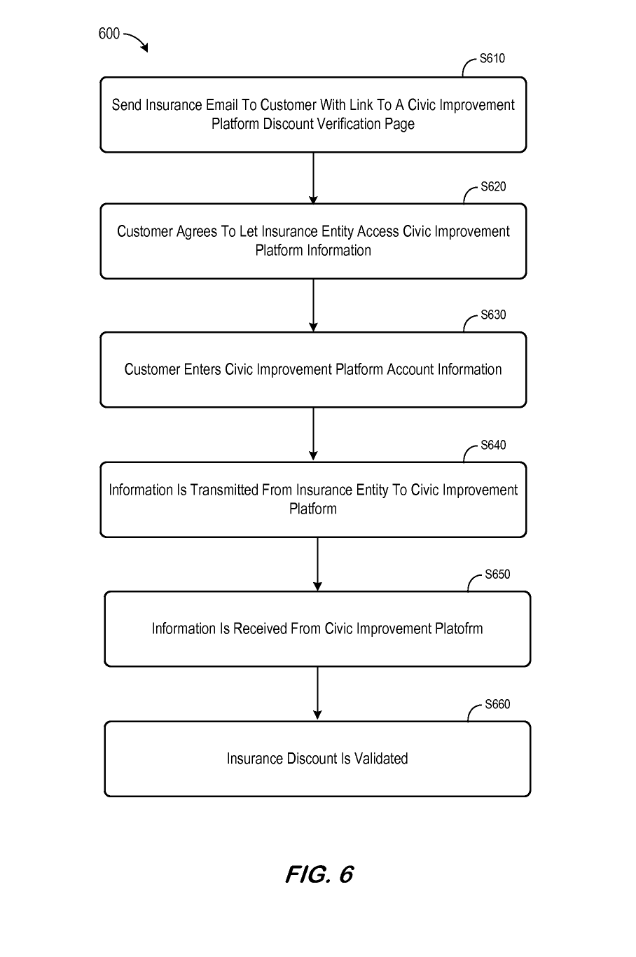

According to some embodiments, users who generate a lot of safety reports in connection with a civic improvement platform may be considered more safety conscious as compared to other users and, therefore, may represent a better insurance risk. As a result, an insurance discount or other benefits might be provided to such users. Note, however, that an insurance company may want to verify that a user has, in fact, generated those safety reports. FIG. 6 illustrates a verification process 600 according to some embodiments of the present invention.

At S610, an insurance email may be transmitted to a customer with a link to a civic improvement platform discount verification page. The customer may then agree at S620 to let the insurance company access his or her civic improvement platform information (e.g., the safety reports he or she has submitted). At S630, the customer provides his or her civic improvement platform account information (e.g., a username and password). At S640, the insurance company may transmit that account information to the platform and receives the customer's safety report data from the platform at S650. In this way, the insurance discount for the customer may be verified at S660.

In this way, a new business or renewal customer may be asked if they are active with a civic improvement platform. If they are, he or she may be asked to consent allowing the insurer to access the reporting history and sign into a portal that enables the insurer to extract the civic improvement platform's data. According to some embodiments, if that type of functionality is not available, the insurer might mail and/or email a form to be completed by the policy holder. The form might ask for print outs and/or extracts of reports made to any civic improvement platform. The policy holder could then mail or email this information to insured to be processed either by an automated tool or third party vendor. Once verified, the discount may be applied if appropriate.

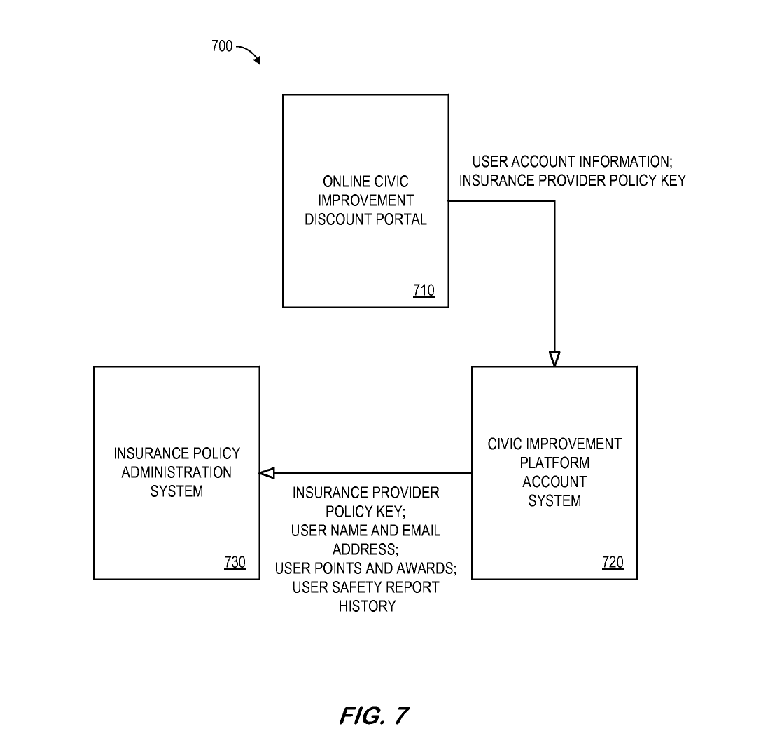

FIG. 7 is a verification data flow 700 according to some embodiments of the present invention. According to this embodiment, an online civic improvement discount portal 710 transmits data to a civic improvement platform account system 720. In particular, the portal 710 transmits user account information along with an insurance provider policy key to the civic improvement platform account system 720. The civic improvement platform account system 720 may then transmit data to an insurance policy administration system 730. In particular, the civic improvement platform account system 720 may transmit the insurance provider policy key, a user name and email address, user points and/or awards (e.g., a special title or status achieved by the user), along with a user safety report history. The insurance policy administration system 730 may then use this information in connection with an underwriting decision.

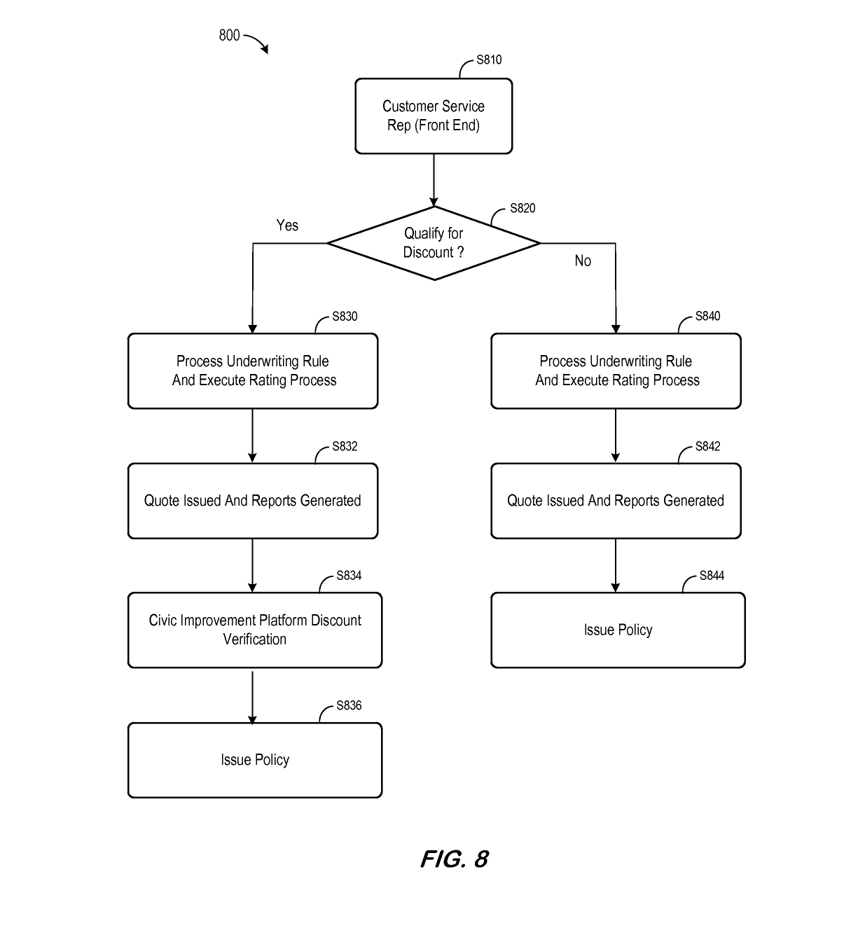

FIG. 8 is a process work flow 800 associated with a new insurance policy according to some embodiments of the present invention. At S810, a customer service representative may ask a potential insurance customer if he or she uses a civic improvement portal (in which case he or she would qualify for a discount similar to a “good student” insurance discount). If the customer does qualify at S820, underwriting rules may be processed and a rating process may be executed at S830 (e.g., a customer who has earned “50 points” from a civic improvement platform might receive a 10% discount for an insurance product). The appropriate insurance quote may be issued and any necessary reports generated at S832. A civic improvement process discount verification may be performed at S834 (e.g., as described in connection with FIGS. 6 and 8 herein), and the insurance policy may then be issued at S836.

If the customer does not qualify for the discount at S820, underwriting rules may be processed and a rating process may be executed at S840. The appropriate insurance quote may be issued (without the discount) and any necessary reports generated at S842. The insurance policy may then be issued at S844.

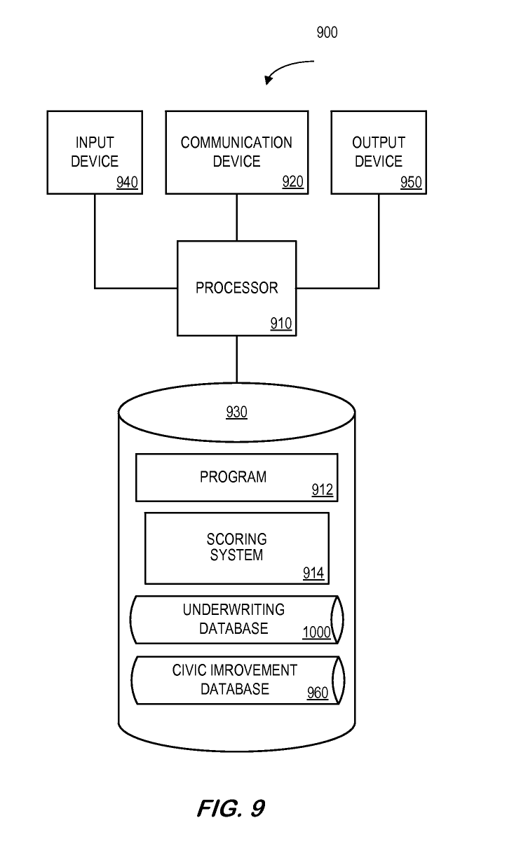

The processes described herein may be performed by any suitable device or apparatus. FIG. 9 is one example of an insurance platform 900 according to some embodiments. The insurance platform 900 may be, for example, associated with the system 400 FIG. 4. The insurance platform 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote user devices and/or civic improvement platforms. The insurance platform 900 further includes an input device 940 (e.g., a mouse and/or keyboard to enter insurance discount information) and an output device 950 (e.g., a computer monitor to display aggregated insurance reports and/or results to an administrator).

The processor 910 also communicates with a storage device 930. The storage device 930 may comprise any appropriate information storage device, including combinations of magnetic storage devices (e.g., a hard disk drive), optical storage devices, and/or semiconductor memory devices. The storage device 930 stores a program 912 and/or scoring system 914 for controlling the processor 910. The processor 910 performs instructions of the programs 912, 914, and thereby operates in accordance with any of the embodiments described herein. For example, the processor 910 may receive civic improvement platform data associated with a potential entity to be insured, wherein the civic improvement platform data is associated with user safety reports received by the civic improvement platform. The processor 910 may also analyze the civic improvement platform data and/or transmit an underwriting decision for the potential entity to be insured based at least in part on said civic improvement platform data. Note that as used herein, the phrase “underwriting decision” may refer to any underwriting related decision (e.g., a decision as to pricing, whether or not to issue, etc.).

Referring again to FIG. 9, the programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the insurance platform 900 from another device; or (ii) a software application or module within the insurance platform 900 from another software application, module, or any other source.

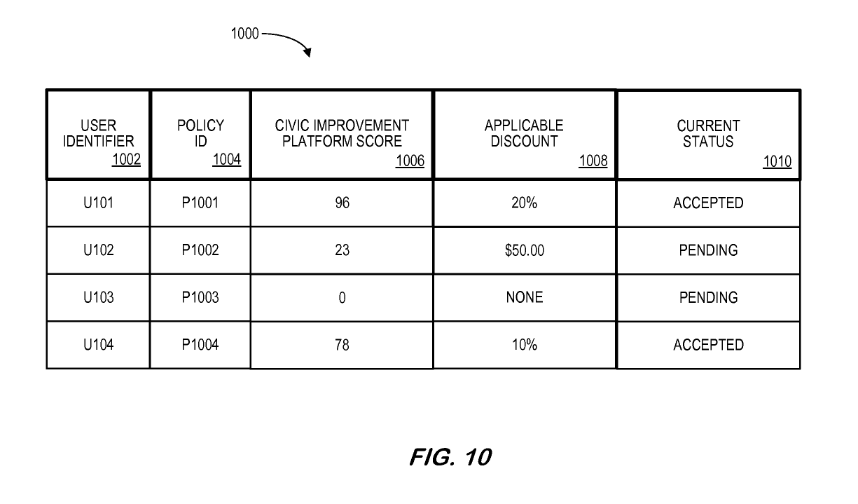

In some embodiments (such as shown in FIG. 9), the storage device 930 stores an underwriting database 1000 and/or civic improvement database 960. An example of a database that may be used in connection with the insurance platform 900 will now be described in detail with respect to FIG. 10. Note that the database described herein is only one example, and additional and/or different information may be stored therein. Moreover, various databases might be split or combined in accordance with any of the embodiments described herein.

Referring to FIG. 10, a table is shown that represents the underwriting database 1000 that may be stored at the insurance platform 900 according to some embodiments. The table may include, for example, entries identifying insurance products that may be offered in connection with electric vehicles. The table may also define fields 1002, 1004, 1006, 1008, 1010 for each of the entries. The fields 1002, 1004, 1006, 1008, 1010 may, according to some embodiments, specify: a user identifier 1002, a policy identifier 1004, a civic improvement platform score 1006, an applicable discount 1008, and a current status 1010. The information in the underwriting database 1000 may be created and updated, for example, whenever data is received from remote insurance agent devices, user devices, and/or civic improvement platforms.

The user identifier 1002 may be, for example, a unique alphanumeric code identifying a customer or potential customer (e.g., a person or business). The policy identifier 1004 might represent an insurance product that may be offered to the user associated with the user identifier 1002. The civic improvement platform score 1006 may be based on a number or quality of user safety reports generated by the user. According to some embodiments, the civic improvement platform score 1006 might represent a badge or title provided to the user (e.g., a “gold” member). The applicable discount 1008 might represent a percentage or dollar amount of discount that will be offered to the user based on his or her civic improvement platform score 1006. The current status 1010 may indicate whether or not the user has accepted the offer of insurance.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the databases described herein may be combined or stored in external systems).

According to some embodiments, when an insurer determines that a user or business has a high incident of loss, business pricing adjustments might be applied across different types of insurance policies and/or a manual underwriting review might be triggered upon renewal of other policies. For example, a business owner might have has home, automobile and business insurance policies with an insurer. The owner's business may receive many civic reports that raise concern of risks to losses. This might trigger an examination of the business owner's auto and home-owner insurance premiums and/or result in further evaluation of the house to prevent further losses.

Applicants have discovered that embodiments described herein may be particularly useful in connection with certain insurance products. Note, however, that other types of products may also benefit from the invention. For example, embodiments of the present invention may be used in conjunction with the rating, pricing and quoting of personal loans, credit lines, and other types of business transactions. Each of these different types of products may benefit from the use of the rating approaches described herein.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system for underwriting insurance policies using civic improvement platform based data, comprising:
a communication device to receive civic improvement platform data associated with a potential entity to be insured, wherein the civic improvement platform data is associated with user safety reports received by the civic improvement platform;
a processor coupled to the communication device; and
a storage device in communication with said processor and storing instructions executed by said processor to:
analyze said civic improvement platform data to assign a civic score to the potential entity to be insured, and
transmit an underwriting decision for the potential entity to be insured based at least in part on said civic score.

2. The system of claim 1, the underwriting decision comprising at least one of: (i) a premium for an insurance policy decision, (ii) a benefit for an insurance policy decision, (iii) an insurance policy renewal decision, and (iv) an insurance policy premium adjustment decision.

3. The system of claim 1, the
civic score being based on (i) safety report frequency data and (ii) safety report quality data; and the processor calculates an insurance premium discount for the potential entity to be insured based on the assigned civic score.

4. The system of claim 1, the storage device further storing instructions executed by said processor to determine at least one of a route or location associated with the potential entity of be insured based on safety reports.

5. The system of claim 1, the storage device further storing instructions executed by said processor to trigger a loss control response based on safety reports.

6. The system of claim 1, the insurance policy comprising at least one of: (i) automobile insurance, (ii) life insurance, (iii) a wealth management insurance product, (iv) personal injury insurance, and (v) property insurance.

7. The system of claim 1, the potential entity to be insured comprising: (i) a person, or (ii) a business.

8. The system of claim 1, the civic improvement platform forwarding information associated with user safety reports to at least one of: (i) a governmental agency, and (ii) a public utility.

9. The system of claim 1, the civic improvement platform posting user safety reports to a plurality of users.

10. The system of claim 1, at least one user safety report comprises at least one of: (i) a road condition, (ii) a traffic sign condition, (iii) a streetlight condition, (iv) a traffic light condition, (v) an electrical wire condition, (vi) a water hazard, (vii) a weather hazard, (viii) a street condition, (ix) a plant hazard, (x) a sidewalk condition, (xi) a guardrail condition, and (xii) a criminal activity.

11. The system of claim 10, at least one user safety report including at least one of: (i) a user identifier, (ii) a location, (iii) a time and date, (iv) image information, and (v) an insurance identifier.

12. The system of claim 1, the underwriting decision being based at least in part on: (i) an overall number of safety reports associated with the potential entity to be insured, (ii) a frequency of safety reports associated with the potential entity to be insured, (iii) a quality of safety reports associated with the potential entity to be insured, and (iv) a point value associated with the potential entity to be insured.

13. The system of claim 1,
the storage device further storing instructions executed by said processor to receive, from the potential entity to be insured, permission to access the civic improvement platform data.

14. The system of claim 13, the permission including at least one of: (i) a civic improvement platform username, and (ii) civic improvement platform password.

15. The system of claim 1, the underwriting decision being further based on conventional underwriting data.

16-17. (canceled)

18. A computerized method performed by an insurance underwriting platform, comprising:
receiving civic improvement platform data associated with a potential entity to be insured, wherein the civic improvement platform data is associated with user safety reports received by a civic improvement platform;
analyzing, by a processor, said civic improvement platform data to assign a civic score to the potential entity to be insured; and
transmitting an underwriting decision for the potential entity to be insured based at least in part on said civic score.

19. The method of claim 18, the underwriting decision comprising at least one of: (i) a premium for an insurance policy decision, (ii) a benefit for an insurance policy decision, (iii) an insurance policy renewal decision, and (iv) an insurance policy premium adjustment decision.

20. The method of claim 18, the insurance policy comprising at least one of: (i) automobile insurance, (ii) life insurance, (iii) a wealth management insurance product, (iv) personal injury insurance, and (v) property insurance.

21. The method of claim 18, further comprising:
forwarding, by the civic improvement platform, information associated with user safety reports to at least one of: (i) a governmental agency, or (ii) a public utility.

22. The method of claim 18, at least one user safety report comprising at least one of: (i) a road condition, (ii) a traffic sign condition, (iii) a streetlight condition, (iv) a traffic light condition, (v) an electrical wire condition, (vi) a water hazard, (vii) a weather hazard, (viii) a street condition, (ix) a plant hazard, (x) a sidewalk condition, (xi) a guardrail condition, and (xii) a criminal activity.

23. The method of claim 18, at least one user safety report including at least one of: (i) a user identifier, (ii) a location, (iii) a time and date, (iv) image information, and (v) an insurance identifier.

24-26. (canceled)
